(19) United States
(12) Patent Application Publication
(10) Pub. No.: US 2011/0079085 A1
(43) Pub. Date: Apr. 7, 2011

(54) INTEGRATED FLUID PRESSURE SENSOR SYSTEM

(76) Inventors: Robert John Kanda, Lake Orion, MI (US); Mark Louis Dell'Eva, Grand Blanc, MI (US); Steven Lee Ambrose, Farmington Hills, MI (US)

(21) Appl. No.: 12/574,057

(22) Filed: Oct. 6, 2009

(51) Int. Cl. G01L 7/00

(52) U.S. Cl. 73/714

(57) ABSTRACT

An integrated fluid pressure sensor system includes a printed circuit board, a pressure manifold having a pressure source, and a sensor. The printed circuit board may be coupled to a pressure manifold. The printed circuit board and the pressure manifold may define a pressure cavity. The pressure source can be operatively configured to release fluid into the pressure cavity. The sensor may be affixed to the printed circuit board within the pressure cavity. The sealing member may be disposed between the printed circuit board and the pressure manifold. The gasket may be operatively configured to seal the pressure cavity.

### BACKGROUND

The present disclosure relates generally to an integrated fluid pressure sensor system, including an integrated fluid pressure sensor system for a transmission, turbine, or the like.

Fluid pressure sensors are used in various systems such as transmissions, gas turbines, and diesel after treatment systems or the like. Fluid pressure sensors are typically implemented as a discrete unit having its own housing, wiring port and printed circuit board within the housing. Such pressure sensors are designed to measure in a dynamic mode to capture very high speed changes in pressure. One possible application for this type of sensor is measuring combustion pressure in an engine cylinder or a gas turbine. These sensors are commonly manufactured out of piezoelectric materials, such as quartz.

With reference to FIG. 1, a traditional fluid pressure sensor 112 of a traditional fluid pressure system 110 may have a cylindrical metal body 114 that includes a base 120 wherein a hole (not shown) is formed in the cylindrical metal body 114. The cylindrical metal body 114 may be have a threaded fitting 116 at the base 120 of the cylindrical metal body 114 so that it may be threaded onto the pressure manifold 122 as shown. Alternatively, the sensors 112 have commonly been secured to the pressure system 110 with a securing structure, such as a hold down plate 111.

The cylindrical metal body 114 and the pressure manifold 122 define a cavity 119, which may be associated with a corresponding pressure source 121. Given the separate and discrete nature of the sensors 112 in a traditional pressure sensor arrangement 110, the separate pressure sensors 112 typically must each be separately mounted to the system and separately calibrated. Furthermore, each sensor 112 will generally have its own housing unit 114 and electrical circuit unit (not shown), which can result in comparatively higher costs.

Within these traditional fluid pressure sensor cylindrical housing units 114, a small outline integrated circuit (SOIC, or SOIC package) 4 is disposed. An SOIC 4 is shown in FIGS. 2A, 2B, and 2C. The SOIC 4 measures the pressure changes for a specific system. The SOIC 4 in this example is a surface mounted integrated circuit package that occupies an area about 30-50% less than an equivalent Dual In Line package (“DIP”), with a typical thickness that is about 70% less. The SOIC 4 accordingly is shorter and narrower than a DIP. An SOIC 4 generally has “gull wing” leads 6 (as shown in FIGS. 2A, 2B, and 2C) that protrude from the two long sides 8, and a lead spacing of 1.3 mm. The SOIC 4 may be installed within the cylindrical metal body 114 (e.g., see FIG. 1). A wiring port 118 is also typically disposed at the top of cylindrical metal body 114 to provide electrical communication to and from the SOIC 4

As noted above, the cylindrical metal body 114 of a traditional sensor 112 is mounted directly to a system, such as a transmission system, by either a snap fit connection or a threaded cylindrical metal body 114. Such a connection between the cylindrical metal body 114 and the system may impose stresses on the SOIC 4, that could adversely affect the operating characteristics of the SOIC 4.

Furthermore, the tolerance stack-up between the pressure port (not shown) on a traditional sensor 112 and the pressure port 121 on the pressure manifold 122 is larger than the allowable worst case statistical stack-up. As a result, the seal (not shown) for a traditional sensor 112 may undesirably extend beyond the planar sealing surface of the traditional sensor 112.

Moreover, by having separate and discrete pressure sensors 112, each having separate cylindrical metal bodies 114 and operating independently of one another, the design can involve increased cost and complexity. A potential challenge includes obtaining proper sealing between the pressure sensors 112 and the pressure manifold 122 without compromising the operating characteristics of the SOIC 4 as indicated above. Therefore, it can be desirable to improve sealing interfaces between the sensor 112 and the hydraulic pressure source.

### SUMMARY

An integrated fluid pressure sensor system in accordance with embodiments disclosed herein includes a printed circuit board, a pressure manifold having a pressure source, a sealing member, and a sensor. The printed circuit board is coupled to a pressure manifold. The printed circuit board and the pressure manifold define a pressure cavity. The pressure source may be operatively configured to release fluid into the pressure cavity. The sensor may be affixed to the printed circuit board within the pressure cavity. The sealing member may be disposed between the printed circuit board and the pressure manifold. The sealing member may be operatively configured to seal the pressure cavity.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 a perspective view of a prior art fluid pressure sensor in a transmission.

FIG. 2A is a plan view of a small outline integrated circuit package.

FIG. 2B is a side view of a small outline integrated circuit package.

FIG. 2C is a front view of a small outline integrated circuit package.

FIG. 3 is a cross-sectional view of a first embodiment of the present disclosure.

FIG. 4 is a cross-sectional view of a second embodiment of the present disclosure.

FIG. 5A is a plan view of an example seal plate.

FIG. 5B is a plan view of an example gasket.

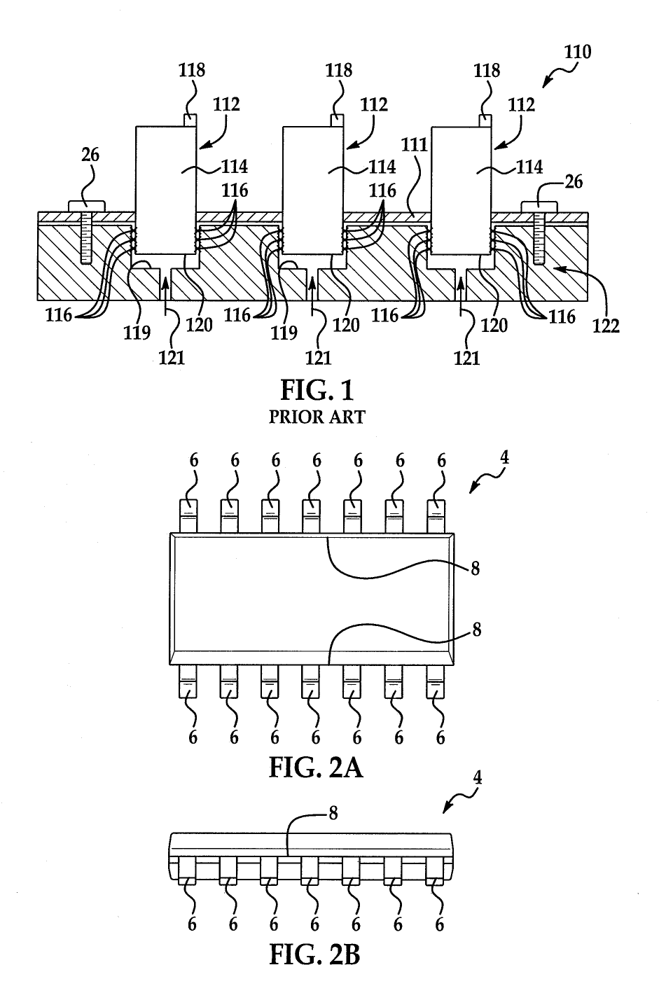

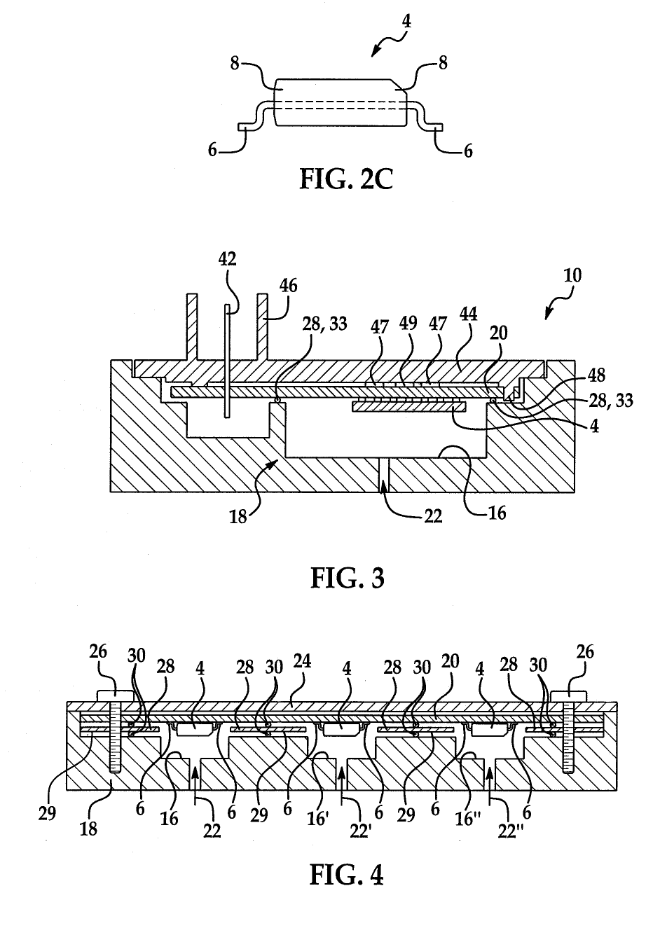

### DETAILED DESCRIPTION

A sealing system for a fluid sensor 10 is disclosed in which a sensor(s) 4 is provided in a manifold pocket or cavity 16 such that the complete sensor(s) 4 may be immersed or exposed to a media fluid. By providing a sensor 4 that can be completely immersed in the fluid, the location of the sensor port may be less critical and the seal can be moved to an area on the sensor circuit board 20 such that additional strain is not applied to the sensor 4. If additional strain is applied to a sensor 4 such that the sensor's 4 operational characteristics may be affected, the inclusion or implementation of one or more additional sensors may be employed to provide a measure of compensation.

Referring now to FIG. 3, an embodiment of the present disclosure is shown. The integrated fluid pressure sensor system 10 includes a printed circuit board (or a circuit card) 20 coupled to a pressure manifold 18. The printed circuit board 20 and the pressure manifold 18 define a pressure cavity 16. The pressure manifold 18 includes a pressure source 22 that is operatively configured to release fluid, such as the non-limiting example of transmission fluid, into the pressure cavity 16. A sensor 4 is affixed to the printed circuit board 20 within the pressure cavity 16. As used herein, the term “affixed” is used broadly and contemplates various forms for affixing, attaching, or otherwise connecting the associated components. The sensor 4 may further include resistors 47 and capacitors 49 mounted on the circuit card/printed circuit board 20. The resistors 47 and capacitors 49 may be disposed between a housing (e.g, plastic molded housing 44) and the printed circuit board 20, for example, as generally shown in FIG. 3. A sealing member 28 such as, but not limited to a gasket 33 or an o-ring or a seal plate 31, may be disposed between the printed circuit board 20 and the pressure manifold 18. The sealing member 28 may be operatively configured to seal the pressure cavity 16 at a joint between the printed circuit board 20 and the pressure manifold 18.

As shown in FIG. 3, a connector pin 42 may be disposed within the circuit card or printed circuit board 20, and may be further disposed within a plastic housing 44 having a molded-in connector shell 46. The connector pin 42 may be operatively configured to break out electrical connections (not shown) for the sensor 4 and circuit card/printed circuit board 20 to an outside or non-wet environment. As shown in FIG. 3, plastic housing 44 may be affixed to pressure manifold 18. The plastic housing 44 may, for example and without limitation, be affixed to the pressure manifold 18 through heat stakes 48 as shown, or various other conventional mechanical fasteners (not shown). The plastic housing 44 may also be affixed to the pressure manifold 18 by implementing a hold down plate (not shown) on top of the plastic housing 44 such that the hold down plate serves, at least in part, to affix or secure the plastic housing 44 between the hold down plate and the pressure manifold 18. In the embodiment shown in FIG. 3, a gasket 33 is implemented to seal the pressure cavity 16. The gasket 33 may include an opening 35 that substantially corresponds to the dimensions of the pressure cavity 16.

Referring now to FIG. 4, another embodiment of the present disclosure is shown in which the integrated fluid pressure sensor system 10 may further include a plurality of sensors, including, for example, a second sensor 4 affixed to the printed circuit board 20. A plurality of sensor(s) 4 may be affixed to the printed circuit board 20, for example, by using a soldering process.

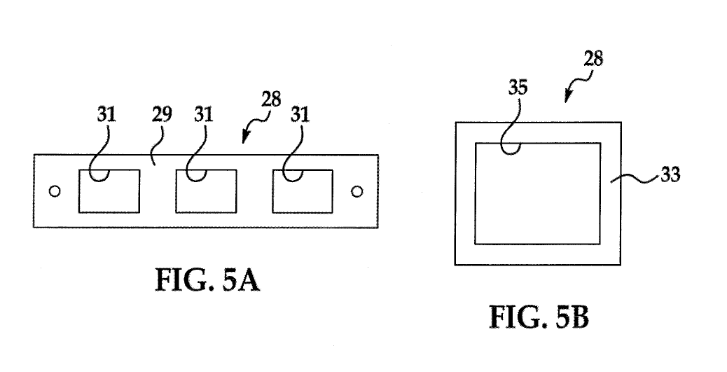

The pressure manifold 18 and the printed circuit board 20 may define a second pressure cavity 16′ that may contain a second sensor 4. With such an embodiment, the pressure manifold 18 may include a second pressure source 22′ that may be operatively configured to release fluid into the second pressure cavity 16′, for example, as shown in FIG. 4. To assist with the sealing of a second pressure cavity 16′, a second gasket (not shown) or a sealing plate 28 may be disposed between the printed circuit board 20 and the pressure manifold 18. The sealing member 28 (shown as seal plate 29 in FIG. 4) may be operatively configured to also seal the second pressure cavity 16′. As additional sensors 4 are added (such as a third sensor), additional pressure cavities (such as a third pressure cavity 16″) may be defined to correspond to additional sensors 4, such as those shown, for example, in FIG. 4. It is to be understood that the sealing member 28 (in the form of a seal plate 29 shown in FIG. 5A or gasket(s) shown as 33 in FIG. 5B) may be made of a polymeric material and the pressure manifold 18 may be made of plastic, aluminum, steel or other suitable materials.

As indicated above, the sealing member 28 may also be comprised of a seal plate 29 (shown as 29 in FIG. 5A) instead of a gasket (shown as 33 in FIG. 3 and FIG. 5B wherein such a seal plate 29 can properly seal one or more respective pressure cavities 16, 16′, 16″ (shown in FIG. 4). Such a seal plate 29 may operate and function in substantially the same way as the gasket 33 and may likewise be positioned between the pressure manifold 18 and the printed circuit board 20. Such a seal plate 29 may be made from plastic wherein where the plastic is injection molded to create a plate-like structure having openings 31 defined therein. The openings 31 in the seal plate 29 may coincide with one or more pressure cavities. A polymeric material such as, but not limited to silicone rubber 30 may be injected molded onto the seal plate 29 to further enhance sealing properties. Silicone rubber or other sealing material 30 may be utilized in instances in which the sealing member 28 is a seal plate 29. The seal plate 29 may be positioned at a joint between the printed circuit board 20 and the pressure manifold 18. Like the gasket 33, a seal plate 29 may be a sealing member 28 between the pressure manifold 18 and the printed circuit board 20 about the perimeter of the pressure cavity to better prevent leakage between the pressure manifold 18 and the printed circuit board 20.

As generally illustrated in FIG. 4, a hold down plate 24 may also be used with the integrated pressure sensor system 10 wherein the hold down plate 24 is affixed to the printed circuit board 20 and the pressure manifold 18. A mechanical fastener 26 is a non-limiting example of a means or device that may be used to affix the hold down plate 24 to the printed circuit board 20 and the pressure manifold 18.

A method for manufacturing a device of type is also contemplated by the present disclosure. The method for manufacturing an integrated fluid pressure sensor system 10 may include: (1) providing a printed circuit board 20 having a sensor 4 affixed to the printed circuit board 20; (2) providing a sealing member; (3) coupling the printed circuit board 20 to a pressure manifold so that the gasket is disposed between the printed circuit board 20 and the pressure manifold 18, the printed circuit board 20 and the pressure manifold 18 defining a pressure cavity operatively configured to house the sensor 4; (4) providing a hold down plate 24; and (5) affixing the hold down plate 24 to the printed circuit board 20 and the pressure manifold 18. It should also be noted that if, for instance, the gasket-like member comprises a sealing plate 29, the a step of providing silicone on the sealing plate 29 may optionally be added.

It is also to be understood that the method for manufacturing an integrated fluid pressure sensor system 10 of the present disclosure may further include the step of providing a second sensor affixed to the printed circuit board 20. A second sensor 4′ may be disposed within a corresponding second pressure cavity 16′ defined by the printed circuit board 20 and the pressure manifold 18. To the extent additional sensors are provided, such additional sensors 4 may also be provided in a corresponding and separate pressure cavity 16, for example as shown in FIG. 4. Further such sensors 4 may be soldered to the printed circuit board 20 within the pressure cavity 16.

While multiple embodiments of the present disclosure have been described in detail, it will be apparent to those skilled in the art that the disclosed embodiments may be modified. Therefore, the foregoing description is to be considered exemplary rather than limiting.

What is claimed is:

1. An integrated fluid pressure sensor system comprising:
a printed circuit board coupled to a pressure manifold, the printed circuit board and the pressure manifold defining a pressure cavity, the pressure manifold including a pressure source being operatively configured to release fluid into the pressure cavity;
a sensor affixed to the printed circuit board within the pressure cavity; and
a sealing member disposed between the printed circuit board and the pressure manifold, the sealing member being operatively configured to seal the pressure cavity.

2. The integrated fluid pressure sensor system as defined in claim 1, further comprising:
a second sensor affixed to the printed circuit board;
wherein the pressure manifold and the printed circuit board define a second pressure cavity containing the second sensor, the pressure manifold including a second pressure source being operatively configured to release fluid in the second pressure cavity; and
a second sealing member disposed between the printed circuit board and the pressure manifold, the second sealing member being operatively configured to seal the second pressure cavity.

3. The integrated fluid pressure sensor system as defined in claim 1, further comprising a second polymeric material disposed on an upper surface and a lower surface of the sealing member.

4. The integrated fluid pressure sensor system as defined in claim 1, further comprising a hold down plate affixed to the printed circuit board and the pressure manifold.

5. The integrated fluid pressure sensor system as defined in claim 4, further comprising a mechanical fastener operatively configured to affix the hold down plate and the printed circuit board to the pressure manifold.

6. The integrated fluid pressure sensor system as defined in claim 2, wherein the pressure manifold is comprised of aluminum.

7. The integrated fluid pressure sensor system as defined in claim 1, wherein the sealing member is comprised of a polymeric material.

8. An integrated fluid pressure system comprising:
a printed circuit board coupled to a pressure manifold, the printed circuit board and the pressure manifold defining a pressure cavity, the pressure manifold including a pressure source being operatively configured to release fluid into the pressure cavity;
means for sensing pressure changes within the pressure cavity, the sensing means being affixed to the printed circuit board; and
means for sealing the pressure cavity, the sealing means being disposed between the printed circuit board and the pressure manifold.

9. The integrated fluid pressure system as defined in claim 8 wherein the sensing means is a small outline integrated circuit.

10. The integrated fluid pressure system as defined in claim 8 wherein the sealing means is a gasket.

11. The integrated fluid pressure system as defined in claim 8 wherein the sealing means is a seal plate.

12. The integrated fluid pressure system as defined in claim 8, further comprising a hold down plate affixed to the printed circuit board and the pressure manifold.
